(19) United States
(12) Patent Application Publication
(10) Pub. No.: US 2011/0254231 A1
(43) Pub. Date: Oct. 20, 2011

(54) Clean-In-Place Seal Assembly

(76) Inventors: Timothy J. Isenberg, Marshfield, WI (US); John E. Zirbel, Marshfield, WI (US)

(21) Appl. No.: 13/089,009

(22) Filed: Apr. 18, 2011

Related U.S. Application Data
(60) Provisional application No. 61/325,612, filed on Apr. 19, 2010.

(51) Int. Cl. F16J 15/16

(52) U.S. Cl. 277/500

(57) ABSTRACT

A seal assembly is provided that can be automatically cleaned in place, without requiring manual cleaning by a technician, and that can be used with food processing equipment. The seal assembly has a back plate that is attached to a wall of the food processing equipment and a seal cover that connects to the back plate. A cavity is defined between the seal cover and a rotating shaft that extends into the seal assembly, and a cleaning fluid may be introduced into the cavity. The cavity may house a pair of seals that are longitudinally spaced from each other and a hub collar between the seals and which may influence a fluid flow path of the cleaning fluid through the cavity.

### CROSS-REFERENCE TO RELATED APPLICATIONS

This application claims priority from U.S. Provisional Patent Application Ser. No. 61/325,612 filed on Apr. 19, 2010, the entirety of which is expressly incorporated by reference herein.

### BACKGROUND OF THE INVENTION

1. Field of the Invention

The invention relates to food processing equipment and, more particularly, to seals for shafts of rotating components within food processing equipment.

2. Discussion of the Related Art

Seals are known for sealing openings through which shafts of rotating components extend through walls of food processing equipment.

Clean-in-place systems for use with food processing equipment are also known in the food processing industries. Typically, such clean-in-place systems automatically spray cleaning fluid inside of food processing equipment.

### SUMMARY OF THE INVENTION

The inventors have recognized that in typical food processing equipment such as vats and other food processing machines, prior art clean-in-place systems have been primarily designed to clean the inside walls of the vat or machine and large mechanical components that are housed in it, such as agitator or mixing devices, while other parts of the overall system have not been cleaned with these known clean-in-place systems. The inventors have also recognized that in typical food processing vats and other food processing machines, shaft seals for shafts of rotating assemblies must be manually cleaned by technicians and, at times, are unable to be cleaned at the interfaces of the seals and the rotating components. The present invention contemplates a shaft seal that addresses these and other inventor identified problems and drawbacks of the prior art.

In accordance with an aspect of the invention, a seal assembly for use with a clean-in-place system is provided that may be used with a food processing vat or other food processing machine. The seal assembly includes a seal that fits concentrically around and engages a shaft. A seal cover concentrically surrounds the seal and the shaft so that a cavity is defined between the seal cover and the shaft. The seal cover may include a fluid passage for introducing cleaning fluid into the cavity and which may allow the seal assembly to be cleaned in place.

In accordance with another aspect of the invention, the cavity is adjacent the seal so that the cleaning fluid introduced into the cavity can disengage the seal from an outer circumferential surface of the shaft. This may allow the cleaning fluid to flow past the seal and purge the cavity with the cleaning fluid so as to clean the seal assembly in place.

In accordance with another aspect of the invention, the seal assembly is mounted to a food processing machine. The food processing machine may be a cheese vat or a non-enclosed or other food processing machine. The cleaning fluid that flows circumferentially around the shaft can flow out of the seal assembly and into the food processing machine, which collects the cleaning fluid after it purges the cavity and which may therefore allow the seal assembly to be cleaned in place.

In accordance with another aspect of the invention, a cleaning fluid supply line delivers the cleaning fluid to the fluid passage of the seal cover. The seal assembly may be mounted to the wall of the food processing machine so that a connection between the cleaning fluid supply line and an inlet of the fluid passage is provided outside of the food processing machine. This may enhance serviceability of the seal assembly by providing connections outside of the vat.

In accordance with another aspect of the invention, the seal assembly may fluidly connect to a port that extends through a wall of the food processing machine. The seal assembly may include a back plate that is mounted to the wall of the food processing machine. The back plate has a bore that opens into the port of the wall of the food processing machine, and the seal cover is connected to the back plate. This may allow the cleaning fluid to collect in the food processing machine and allow the seal assembly to be cleaned in place.

In accordance with another aspect of the invention, first and second seals are housed within the seal cover. The first and second seals may be longitudinally spaced from each other and be positioned on opposing sides of the cavity. The cleaning fluid that flows through the cavity can flow past the first seal, but not the second seal. This may allow the seal assembly to remain sealed at one end while purging the cavity with cleaning fluid that flows out of the other end so as to clean the seal assembly, in place.

In accordance with another aspect of the invention, the seal includes a lip that resiliently engages the shaft so that cleaning fluid that is introduced into the cavity can force the lip to disengage from the shaft and allow the cleaning fluid to flow past the seal. This may allow the cleaning fluid to flow out of an end of the seal assembly and allow the seal assembly to be cleaned in place.

In accordance with another aspect of the invention, the seal assembly includes a hub collar that is provided concentrically around the shaft and in the cavity. The hub collar may include guides that direct the cleaning fluid in a flow path through the cavity. The hub collar may be provided in the cavity and between a pair of seals on opposing sides of the cavity, and the guides may direct the cleaning fluid in a generally radial direction, inwardly, toward the shaft. The hub collar may include a side wall and the guides may be defined by bores that are spaced from each other and extend through the side wall. The bores may extend angularly through the side wall, so that cleaning fluid is delivered through the bores angularly toward the shaft. This may establish a fluid flow path within the cavity in which the cleaning fluid flows circumferentially around the shaft, which may enhance washing of the shaft and seal assembly components while the cavity is being purged with cleaning fluid.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an isometric view from above and in front of a vat system incorporating a clean-in-place seal assembly in accordance with the present invention;

FIG. 2 is an isometric view from above and in back of the vat system of FIG. 1;

FIG. 3 is a sectional view of the vat system of FIG. 1;

FIG. 4 is a close up sectional view of a seal assembly of FIG. 3, taken at the curved line 4-4 of FIG. 3;

FIG. 5 is a partial top plan view of the seal assembly and other components of the vat system of FIG. 1;

FIG. 6 is a sectional view of the seal assembly and other components of the vat system of FIG. 1;

FIG. 7 is an exploded sectional view of the seal assembly of FIG. 4; and

FIG. 8 is a sectional view of a hub collar of the seal assembly of FIG. 4;

FIG. 9 is a side elevation of the hub collar of FIG. 4; and

FIG. 10 is a sectional view of the hub collar of FIG. 9, taken at the line 10-10 of FIG. 9.

### DETAILED DESCRIPTION OF THE INVENTION

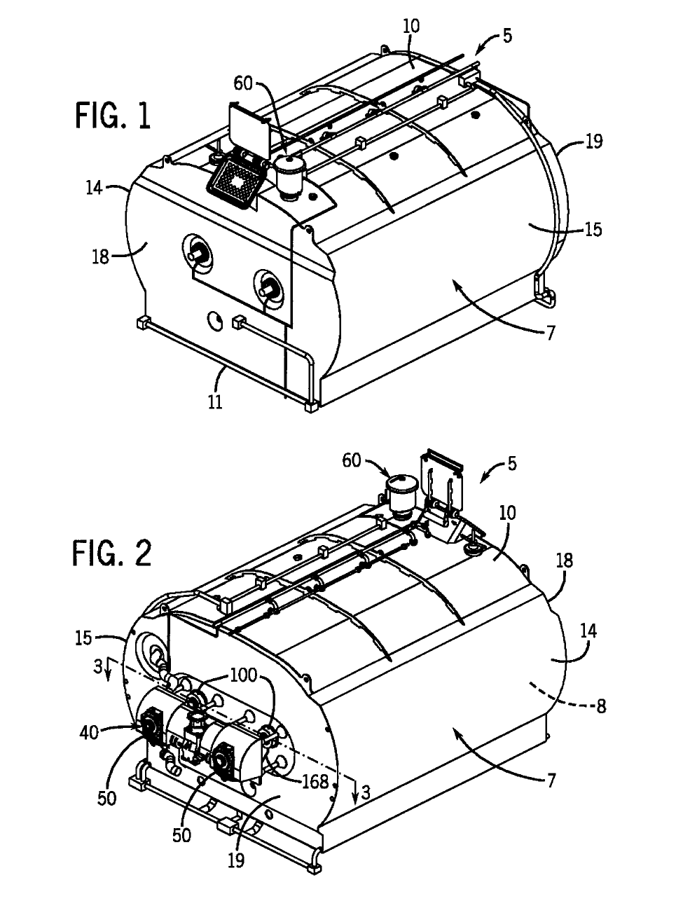

FIG. 1 illustrates a clean-in-place seal assembly 100 being implemented within a vat system 5. Vat system 5 can be used for processing food and related products. The clean-in-place seal assembly 100 is described as being used in the vat system 5 to simplify its explanation, while noting that the clean-in-place seal assembly 100 in other embodiments may be implemented in various non-enclosed or other food processing machines, and/or other suitable machines having bushing-supported rotating components.

Referring now to FIGS. 1 and 2, vat system 5 can be used for processing the food and related products (collectively referred to as “vat contents”) by mechanically manipulating and heating or cooling the vat contents, depending on the particular food or related product being processed. In a representative application, the vat system 5 may be used in the production of cheese, although it is understood that the vat system 5 may be used in processing other types of food products. The system 5 includes a vat 7 that has an agitation system 40 which performs the mechanical manipulations tasks by using a motor that delivers power to a pair of drives 50 (FIG. 2) to rotate a pair of shafts 45 upon which blade assemblies are mounted, and a zoned heat transfer system to perform such heating and/or cooling to provide zoned temperature control to the vat 7.

Vat 7 defines an enclosure having a top wall 10, a bottom wall 11, and side walls 14, 15, all of which extend longitudinally between a pair of end walls 18 and 19. The walls 10, 11, 14, 15, 18, 19 are multilayered, having an outer jacket 20 and an inner shell 25 that are spaced from each other. Insulation and various components of the zoned heat transfer system are housed between the jacket 20 and shell 25. The shell 25 is the inmost structure of the vat 7, so that its inner surface surrounds and defines an outer periphery of a void or inside space 8 within the vat 7. A lower part of the inside space 8 resembles two horizontal parallel cylinders that transversely intersect each other, being defined by a lower portion of the shell 25 that has a pair of arcuate depressions which extend along the length of the vat 7, on opposing sides of a longitudinally extending raised middle segment. From the lower portion of the shell 25, opposing side portions extend in an outwardly bowed manner, arching away from each other in a transverse direction of the vat 7. An upper portion of the shell 25 arcs gradually between side portions of the shell 25 and defines an upper perimeter of the inside space 8 of vat 7.

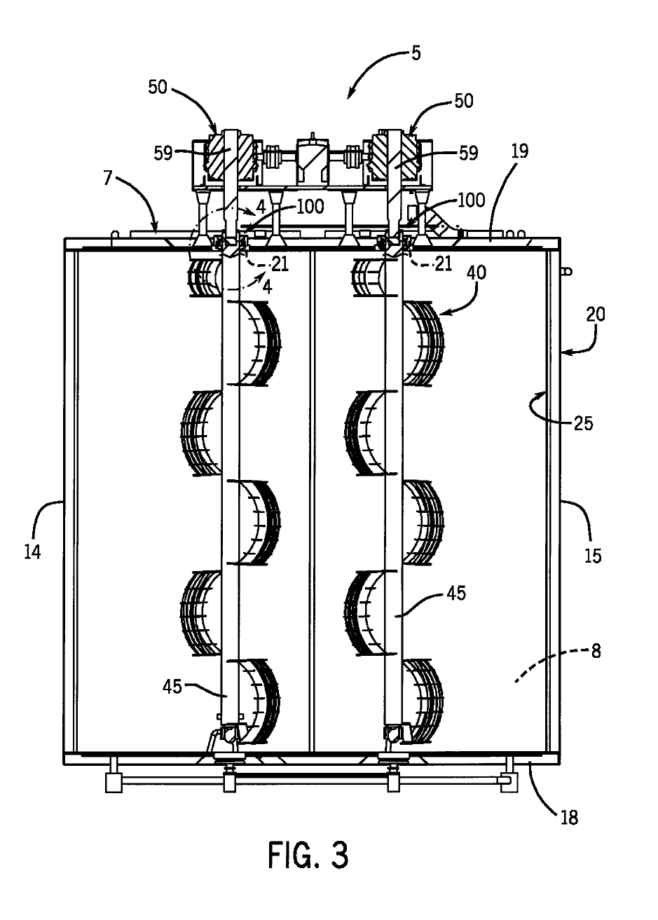

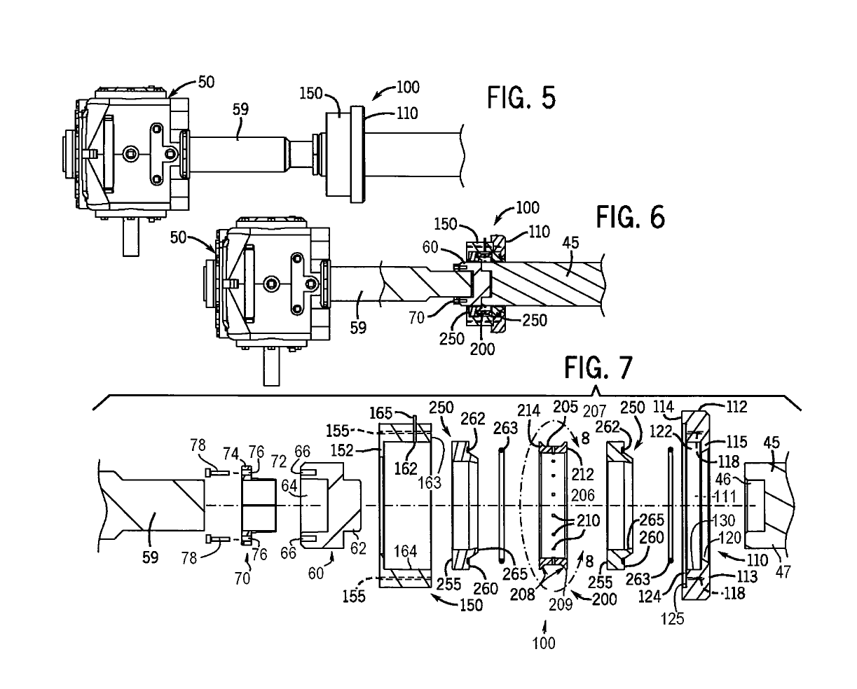

Referring now to FIGS. 3-6, clean-in-place seal assembly 100 includes a back plate 110, a seal cover 150, a hub collar 200, and a pair of seals 250 that engage the shaft 45. The seal cover 150 is connected to the back plate 110, and a cavity 90 is defined between the back plate 110, cover 150, and shaft 45. The hub collar 200 and seals 250 are housed within the seal assembly 100, with the seals 250 at opposing ends of the cavity 90. The shafts 45, back plates 110, seal covers 150, hub collars 200, and seals 250 cooperate to allow their respective interfacing surfaces to be cleaned in place and without requiring manual cleaning by a technician.

Referring now to FIGS. 6 and 7, a portion of an end of each of the shafts 45 that is closest to the drives 50 (FIGS. 3, 5, and 6) is housed in the seal assembly 100. The shaft 45 includes a main body and an adapter 60 that, in this embodiment, extends outwardly from the seal assembly 100 toward the drive 50. The adapter 60 has a reduced diameter portion 62 that inserts into a bore 46 that extends into an end of the main body of the shaft 45. A coupler 70 has a neck 72 that inserts into a bore 64 at a drive-facing end of the adapter 60 of shaft 45. The coupler 70 has a flange 74 with longitudinally extending through-bores 76 that are spaced from each other about the perimeter of coupler flange 74. Fasteners 78 extend through the through-bores 76 of the coupler flange 74 and into cooperating bores 66 that extend into the drive-facing end of the adapter 60. One end of a stub shaft 59 inserts into coinciding bores of the adapter 46 and coupler 47. A second end of stub shaft 59 extends into and is rotated by the drive 50. Rotation of the stub shaft 59 is transmitted through the adapter 46 and coupler 47 and to the shaft 45 within the seal assembly 100, rotating the shaft 45.

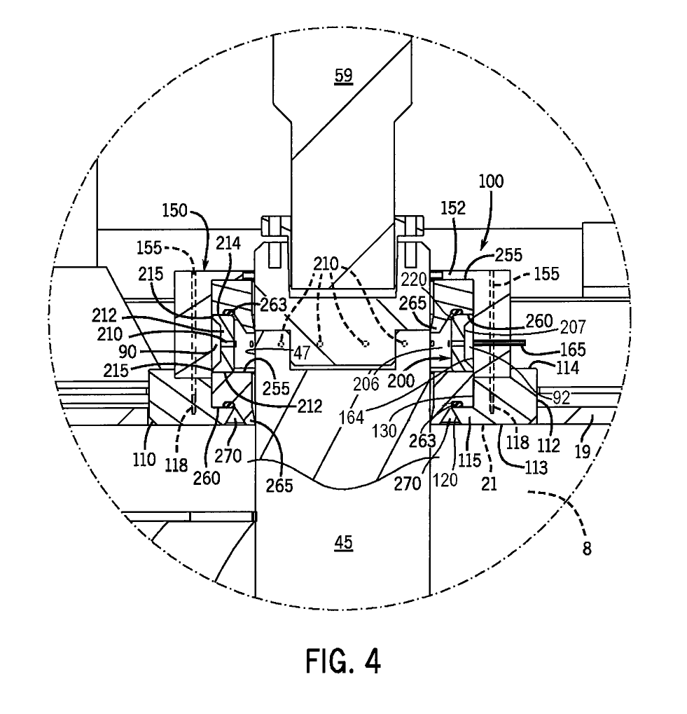

Referring now to FIG. 4, the back plate 110 is attached to the wall 19 and has a bore 111 (FIG. 7) that aligns with a port 21 that extends through the wall 19. The back plate 110 is secured to the wall 19 such as by welding, with the weld extending along the entire perimeter of the back plate 110 so as to establish a liquid-tight connection between the back plate 110 and the vat 7.

Referring now to FIGS. 4 and 7, the back plate 110 includes a side wall 112 that extends between a vat-facing end 113 and a drive-facing end 114 of the back plate 110. The vat-facing end 113 of the back plate 110 includes a flange 115 that extends radially inwardly from the side wall 112 toward a longitudinal axis of the seal assembly 100. The flange 115 has a chamfered inner circumferential surface 120 that tapers outwardly toward the vat wall 19.

Still referring to FIGS. 4 and 7, multiple spaced-apart threaded blind bores 118 extend axially into the drive-facing end 114 end of the back plate 110. A pair of counterbores 122, 124 extends into the drive-facing end 114 of the back plate 110 which provides a stepped inner circumferential surface to the side wall 112. The smaller diameter counterbore 122 extends longitudinally more than halfway through the axial thickness of the back plate 110 and has an inside diameter that corresponds to an outside diameter of the seal 250. The larger diameter counterbore 124 extends slightly below the surface of the drive-facing end 114 and has an inside diameter that corresponds to an outside diameter of the seal cover 150.

Still referring to FIGS. 4 and 7, seal cover 150 serves as a cap for the seal assembly 100 and is seated against the back plate 110. Seal cover 150 includes an end wall 152 and a circumferential side wall 160 that extends longitudinally from a perimeter of the end wall 152. A fluid passage 162 (FIG. 7) extends through the side wall 160 for delivering cleaning fluid into the cavity 90. In the embodiment of FIG. 7, an inlet 165 opens into the fluid passage 162. Shown best in FIG. 2, a cleaning fluid supply line 168 delivers cleaning fluid to the inlet 165 and thus into the fluid passage 162 that directs the fluid to the cavity 90. The cleaning fluid supply line 168 is connected to a known clean-in-place system (including suitable plumbing components, hardware components, and controls) that is configured to deliver cleaning fluid for automatically spraying down predetermined surfaces within the vat system 5. During use of the clean-in-place system, cleaning fluid is conveyed through the cleaning fluid supply line 168 for delivery to the cavity 90 where it washes exposed surfaces of the shaft(s) 45, back plate(s) 110, seal cover(s) 150, hub collar(s) 200, and seals 250.

Still referring to FIGS. 4 and 7, multiple through-bores 155 that are spaced apart from each other about the perimeter of the end wall 152 of seal cover 150 extend longitudinally through the end wall 152 and the side wall 160. The through-bores 155 align with the blind bores 118 of the back plate 110, and fasteners extend through the through-bores 155 and secure into the blind bores 118 to hold the seal cover 150 against the back plate 110. The seal cover 150 is held against the back plate 110, with an end surface 163 of the circumferential side wall 160 abutting a shoulder 125 at the bottom of the larger diameter counterbore 124 of the back plate 110.

Referring again to FIG. 4, the inner surface 164 of the seal cover circumferential side wall 160 and the inner surface 130 of the portion of the back plate side wall 112 that extends around the smaller diameter counterbore 122 align with each other, with such two surfaces being radially spaced the same distance from a longitudinal axis of the seal assembly 100. This gives the cavity 90 a width that is substantially constant along its length. The constant width of the cavity 90 allows the hub collar 200 and seals 250 to have the same outside diameters and fit against respective portions of the inner surfaces of the back plate 110 and seal cover side walls 112, 160.

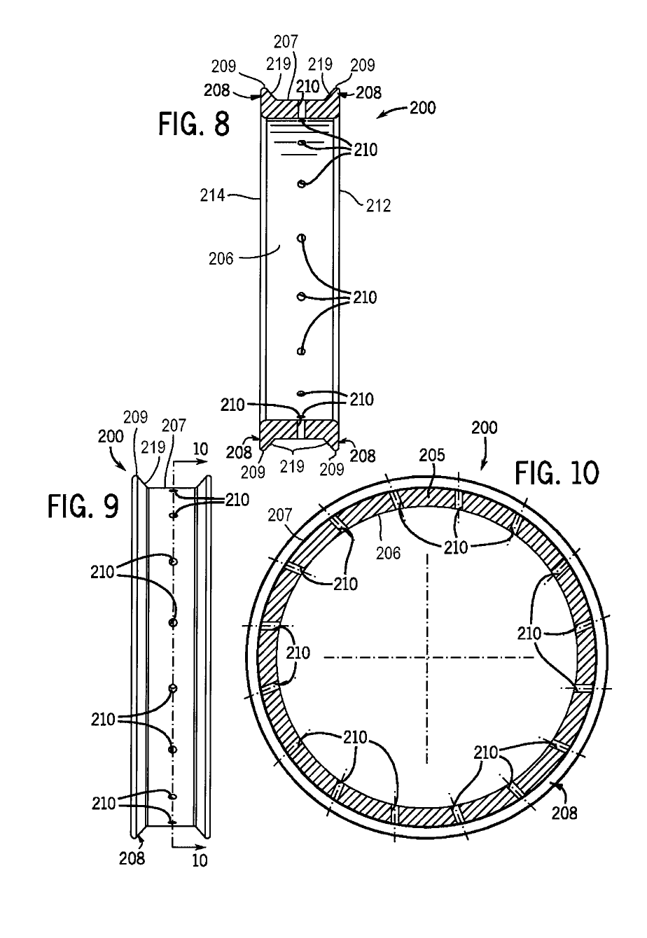

Referring still to FIG. 4, hub collar 200 includes a side wall 205 that has an inner surface 206 which is spaced radially outwardly from an outer surface 46 of the shaft 45. Shown best in FIGS. 8-10, an outer surface 207 of the sidewall 205 is spaced radially inwardly from the inner surface 164 of the seal cover side wall 160. A pair of rims 208 extends from the ends of the hub collar side wall 205 radially outwardly from the outer surface of the side wall 205. Outer surfaces 209 of the rims 208 engage the hub collar side wall 205 (FIG. 4). From the outer surfaces 209, the rims 205 have ramped surfaces 219 that slant angularly toward a middle of the hub collar side wall 205.

Referring now to FIGS. 4, 7, and 8-10, in this embodiment, flow directing guides of the hub collar 200 are defined by bores 210 that extend through the side wall 205. The bores 210 are aligned with and spaced from each other about the periphery of the side wall 205. In this embodiment, each bore 210 extends in a direction that is angular or somewhat tangential with respect to the outer and inner surfaces 207, 206 of the side wall 205. In this configuration, instead of directly colliding with the shaft 45, cleaning fluid that is delivered through the bores 210 substantially maintains its delivery velocity and creates a fluid rotation about the shaft 45 in which the cleaning fluid flows circumferentially around the shaft 45. Front and back ends 212, 214 of the hub collar 200 have flat surfaces that abut the seals 250, maintaining a space 92 between the seals 250 within the cavity 90.

Referring again to FIGS. 4 and 7, each seal 250 has annular back and front end walls 255, 260 and a lip 265 that extends longitudinally from the front end wall 260. In this embodiment, a groove 262 extends into the front end wall 260 and in which an o-ring 263 is installed. Shown best in FIG. 4, the seal 250 that is closest to the vat wall 19 has its (i) front end wall 260 abutting a drive-facing surface of the flange 115 of the back plate side wall 112, with the o-ring 263 compressed between the seal front end wall 260 and flange 115, and (ii) back end wall 255 abutting the front end 212 of the hub collar 200. Also shown best in FIG. 4, the seal 250 that is closest to the drive 50 has its (i) front end wall 260 abutting the back end 214 of the hub collar 200, with the o-ring 263 compressed between the seal front end wall 260 and the flat surface of the hub collar back end 214, and (ii) back end wall 255 abutting an inner surface of the end wall 152 of the seal cover 150. With this construction, the lips 265 of both of the seals 250 face the same direction toward the vat wall 19.

Still referring to FIGS. 4 and 7, each lip 265 resiliently engages the shaft 45 and extends angularly inward from the front end wall 260 so that an innermost edge of the lip 265 defines a smallest inside diameter of the seal 250. The lip 265 reduces its cross-sectional width along its length, with the thickest portion of the lip 265 defined at the intersection of the lip 265 and the front end wall 260 and the thinnest portion of the lip 265 being defined at the front end of the lip 265.

Referring again to FIG. 4, the lip 265 of the seal 250 that is closest to the drive 50 extends under the side wall 205 of the hub collar 200. In this embodiment, a corner 220 of the hub collar 200 defined between the back end 214 and inner surface of the hub collar side wall 205 nests into a corner of the seal 250 defined between the front end wall 260 and lip 265. The lip 265 of the seal 250 that is closest to the vat wall 19 extends through the flange 115 of the back plate 110. The lip 265 of the seal 250 and the chamfered surface 120 of the flange 115 of the back plate 110 extend angularly in diverging directions, defining a clearance 270 between such surfaces and that is triangular in cross-section. Clearance 270 provides enough space to allow the lip 265 to flex out and radially expand when cleaning fluid is being forced into the cavity 90 of the seal assembly 100. This allows cleaning fluid to flow past the front seal 250 nearest the vat wall 19 and purge the cavity 90 with the cleaning fluid so that the cleaning fluid flows into the vat.

Still referring to FIG. 4, in light of the above, when the seal assembly 100 is being cleaned in place, cleaning fluid supply line 168 delivers cleaning fluid to the inlet 165 and thus into the fluid passage 162 that directs the fluid to the cavity 90. The cleaning fluid flows through the bores 210 of the hub collar 200 and flows rotationally through the cavity 90, circumferentially around the shaft 45. As more cleaning fluid flows into the cavity 90, it continues to flow around the shaft 45 and builds pressure within the cavity 90. When pressure builds within the cavity 90, the lip 265 of the seal 250 nearest the drive 50 increases its clamping force against the shaft 45 because the pressurized cleaning fluid within the cavity 90 acts on the outer surface of and tends to radially compress the lip 265 of the rear seal 250. This increases the sealing force that the lip 265 applies against the shaft 45 as a function of the pressure increase within the cavity 90, which prevents the cleaning fluid from flowing out of the seal assembly 100 toward the drive.

Still referring to FIG. 4, at the other end of the seal assembly 100, the seal 250 nearest the vat wall 19 reacts to the pressure increase in the cavity 90 in generally the opposite way as that described above with respect to the seal 250 nearest the drive 50. The lip 265 of the seal 150 nearest the vat wall 19 decreases its clamping force against the shaft 45 because the pressurized cleaning fluid within the cavity 90 acts on the inner surface of and tends to radially expand the lip 265. This flexes the lip 265 outwardly into the clearance 270, allowing cleaning fluid to flow out of the seal assembly 100 and into the vat 7 after the cleaning fluid has washed the respective surfaces of the shaft 45, back plate 110, seal cover 150, hub collars 200, and seals 250, within the seal assembly 100, so that the seal assembly 100 is flushed or purged with the cleaning fluid.

Various alternatives and embodiments are contemplated as being within the scope of the following claims particularly pointing out and distinctly claiming the subject matter regarded as the invention.

I claim:

1. A seal assembly for use with a clean-in-place system comprising:
a seal that fits concentrically around and engages a shaft;
a seal cover that concentrically surrounds the seal and the shaft so that a cavity is defined between the seal cover and the shaft, the seal cover including a fluid passage for introducing cleaning fluid into the cavity.

2. The seal assembly of claim 1, wherein the cavity is adjacent the seal so that the cleaning fluid introduced into the cavity can disengage the seal from an outer circumferential surface of the shaft and flow past the seal for purging the cavity with the cleaning fluid.

3. The seal assembly of claim 2, the seal assembly being mounted to a wall of a food processing machine and positioned so that cleaning fluid that flows past the seal for purging the cavity flows into the food processing machine.

4. The seal assembly of claim 3, further comprising a cleaning fluid supply line delivering the cleaning fluid to the fluid passage of the seal cover, the seal assembly being mounted to the wall of the food processing machine so that a connection between the cleaning fluid supply line and an inlet of the fluid passage is provided outside of the food processing machine.

5. The seal assembly of claim 4, wherein the seal assembly is mounted to an outer surface of the wall of the food processing machine, the seal assembly fluidly connecting to a port that extends through the wall of the food processing machine so that the cleaning fluid that flows past the seal for purging the cavity flows into the food processing machine.

6. The seal assembly of claim 5, further comprising a back plate that is mounted to the wall of the food processing machine and having a bore that opens into the port of the wall of the food processing machine, the seal cover connecting to the back plate.

7. The seal assembly of claim 2, wherein seal cover houses a first seal and a second seal that are spaced from each other, (i) the first seal defining the seal past which the cleaning fluid can flow for purging the cavity with the cleaning fluid, and (ii) the second seal remaining engaged with the outer circumferential surface of the shaft while the cleaning fluid disengages the first seal from the outer circumferential surface of the shaft.

8. The seal assembly of claim 7, wherein the first and second seals are longitudinally spaced from each other and are positioned on opposing sides of the cavity.

9. The seal assembly of claim 8, further comprising a hub collar provided concentrically around the shaft and in the cavity between the first and second seals, the hub collar having guides that direct the cleaning fluid in a generally radial direction toward the shaft.

10. A seal assembly for use with a clean-in-place system comprising:
a seal that fits concentrically around and engages a shaft;
a seal cover extending around the seal and defining a cavity between the seal cover and the shaft, an end of the cavity being adjacent the seal; and
a cleaning fluid supply line connected to the seal cover for delivering cleaning fluid into the cavity.

11. The seal assembly of claim 10, the seal cover further comprising a side wall and a fluid passage that extends through the side wall of the seal cover and connects the cleaning fluid supply line to the cavity.

12. The seal assembly of claim 10, the seal further comprising a lip that resiliently engages the shaft so that cleaning fluid that is introduced into the cavity can force the lip to disengage from the shaft and allow the cleaning fluid to flow past the seal.

13. The seal assembly of claim 10, further comprising a hub collar provided concentrically around the shaft and in the cavity, the hub collar having guides that direct the cleaning fluid in a flow path through the cavity.

14. The seal assembly of claim 13, wherein the hub collar is provided between a pair of seals on opposing sides of the cavity.

15. The seal assembly of claim 13, wherein the guides direct the cleaning fluid in a generally radial direction toward the shaft.

16. The seal assembly of claim 15, the hub collar further comprising a side wall and the guides being defined by bores that are spaced from each other and extend through the side wall.

17. The seal assembly of claim 16, wherein the bores extend angularly through the side wall and deliver cleaning fluid angularly toward the shaft so as to establish a fluid flow path within the cavity in which the cleaning fluid flows circumferentially around the shaft.

18. The seal assembly of claim 17, wherein the seal assembly is mounted to a food processing machine and wherein the cleaning fluid flows (i) circumferentially around the shaft, and (ii) out of the seal assembly and into the food processing machine.
